(19) United States
(12) Patent Application Publication
(10) Pub. No.: US 2024/0202880 A1
(43) Pub. Date: Jun. 20, 2024

(54) DISPLAY SYSTEM INCLUDING DISPLAY APPARATUS OF HEAD-MOUNTED TYPE AND PLURALITY OF VIDEO PROCESSING APPARATUSES

(71) Applicant: CANON KABUSHIKI KAISHA, Tokyo (JP)

(72) Inventor: Takeshi Iwasa, Kanagawa (JP)

(21) Appl. No.: 18/540,456

(22) Filed: Dec. 14, 2023

(30) Foreign Application Priority Data
Dec. 16, 2022 (JP) 2022-200846

(51) Int. Cl. G06T 5/50; G02B 27/01; G06T 7/00

(52) U.S. Cl. CPC G06T 5/50; G02B 27/0172; G06T 7/0002; G06T 2207/20221

(57) ABSTRACT

A display system includes a display apparatus of head-mounted type, a first video processing apparatus including a first CG generation unit that generates CG, and configured to output a display-purpose video image to the display apparatus, and a second video processing apparatus including a second CG generation unit that generates CG, and configured to communicate with the first video processing apparatus, wherein the first video processing apparatus includes an abnormality detection unit that detects an abnormality of a video image input from the second video processing apparatus, or an abnormality of a state of connection with the second video processing apparatus, and a video image selection unit that selects one of a first video image using the CG generated by the first CG generation unit and a second video image using the CG generated by the second CG generation unit as the display-purpose video image, depending on a detection result.

### BACKGROUND

### Field of the Disclosure

The present disclosure relates to a display system, a video processing apparatus, a control method for controlling the video processing apparatus, and a storage medium which are suitable for use in, for example, a mixed reality (MR) system.

### Description of the Related Art

Virtual reality (VR) technology is known as technology that enables experiencing a virtual space. Mixed reality (MR) technology is known as technology that merges a real space and a virtual space in real time and seamlessly. In an MR system using a video see-through type head-mounted display (HMD), a composite image obtained by superimposing computer graphics (hereinafter referred to as CG) on a real space image acquired by an image pickup unit built in the HMD is presented to a person wearing the HMD. These images are independent and correspond to left and right eyes, so that a three-dimensional MR space based on a stereo moving image can be presented to the person wearing the HMD. In VR, a virtual space image is used in place of the real space image.

In general, an MR system includes an HMD that mainly controls image pickup of a real space and display of an MR image, and a personal computer or a workstation that mainly controls generation of a CG image, superimposition on a real space image, and various kinds of image processing. Data such as image data is transmitted between these two, by wired connection using a metal or optical cable, or wireless connection using a wireless local area network (LAN).

There is known a technology of performing interpolation on missing image data to give a feeling of strangeness as little as possible to the person wearing the HMD, even in a case where data transmission is interrupted because of an error or for some other reason in the MR system configured in the manner described above.

For example, Japanese Patent Application Laid-Open No. 2018-005778 discusses a configuration in which a CG image corresponding to the CG image of the most recently received composite image is estimated based on position/posture changes in CG images extracted in the past, and an image for interpolation is generated by superimposing the estimated CG image on the most recently generated picked-up image.

In the related technology discussed in Japanese Patent Application Laid-Open No. 2018-005778, however, the image for interpolation is generated by estimating the CG image from the past information, and the missing image data may not be completely compensated. For this reason, the quality of a video image displayed in an HMD can deteriorate, so that a person wearing the HMD can feel strange, and a sense of immersion in an MR experience can be reduced.

### SUMMARY

According to an aspect of the present disclosure, a display system includes a display apparatus of head-mounted type, a first video processing apparatus including a first computer graphics (CG) generation unit that generates CG, and configured to output a display-purpose video image to the display apparatus, and a second video processing apparatus including a second CG generation unit that generates CG, and configured to communicate with the first video processing apparatus, wherein the first video processing apparatus includes an abnormality detection unit that detects an abnormality of a video image input from the second video processing apparatus, or an abnormality of a state of connection with the second video processing apparatus, and a video image selection unit that selects either one of a first video image using the CG generated by the first CG generation unit and a second video image using the CG generated by the second CG generation unit as a video image to be used for the display-purpose video image, depending on a result of detection by the abnormality detection unit.

Further features of the present disclosure will become apparent from the following description of exemplary embodiments with reference to the attached drawings.

### BRIEF DESCRIPTION OF THE DRAWINGS

FIG. 1 is a diagram illustrating a schematic configuration of a display system according to one or more aspects of the present disclosure.

FIG. 2 is a block diagram illustrating a configuration of the display system according to one or more aspects of the present disclosure.

FIG. 3A is a diagram illustrating processing executed by a video image selection unit in the display system according to one or more aspects of the present disclosure.

FIG. 3B is a diagram illustrating processing executed by the video image selection unit in the display system according to one or more aspects of the present disclosure.

FIG. 3C is a diagram illustrating processing executed by the video image selection unit in the display system according to one or more aspects of the present disclosure.

FIG. 4 is a block diagram illustrating a configuration of a display system according to one or more aspects of the present disclosure.

FIG. 5 is a block diagram illustrating a configuration of a display system according to one or more aspects of the present disclosure.

FIG. 6 is a block diagram illustrating a configuration of a display system according to one or more aspects of the present disclosure.

### DESCRIPTION OF THE EMBODIMENTS

Exemplary embodiments of the present disclosure will be described below with reference to the attached drawings.

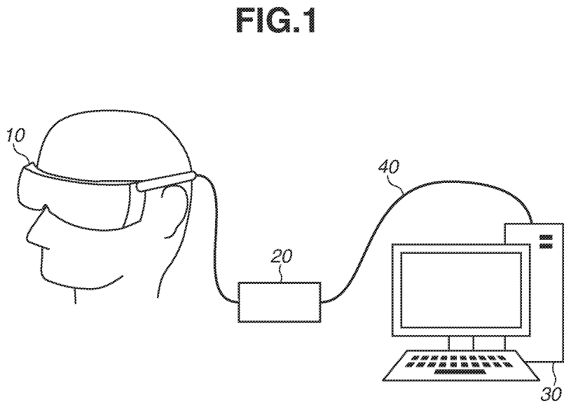

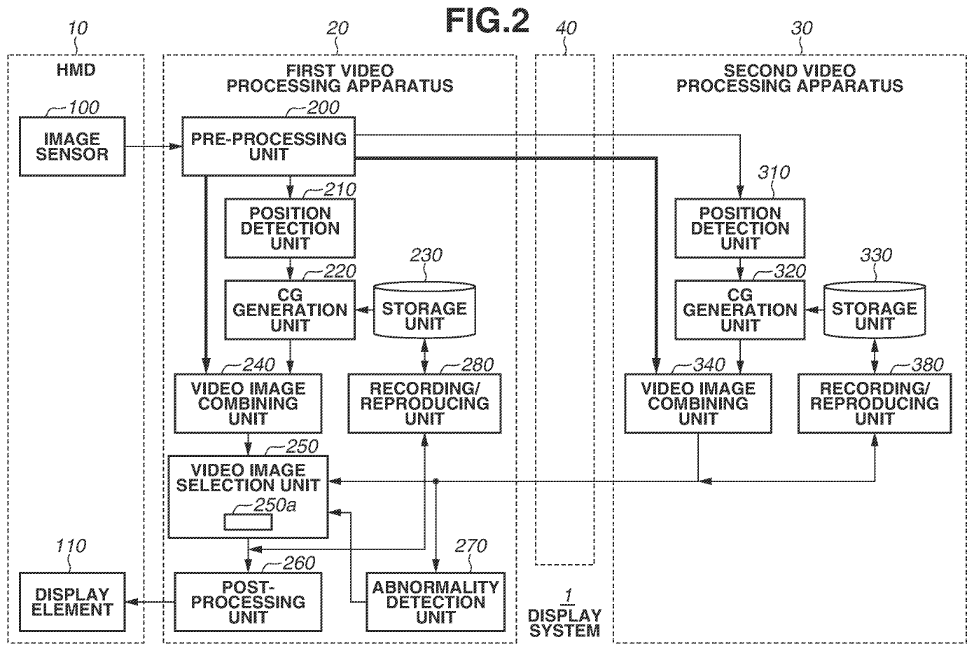

FIG. 1 is a diagram illustrating a schematic configuration of a display system 1 according to a first exemplary embodiment. FIG. 2 is a block diagram illustrating a configuration of the display system 1 according to the first exemplary embodiment.

The display system 1 includes a head-mounted display (HMD) 10 that is a display apparatus of head-mounted type, a first video processing apparatus 20, a second video processing apparatus 30, and a cable 40 connecting the first video processing apparatus 20 and the second video processing apparatus 30, as illustrated in FIG. 1 and FIG. 2. In the present exemplary embodiment, the display system 1 functions as a mixed reality (MR) system that presents a composite video image obtained by superimposing computer graphics (hereinafter referred to as CG) on a real space video image that is a video image picked up by an image pickup unit of the HMD 10, to a person wearing the HMD 10.

The first video processing apparatus 20 is a video processing apparatus that directly controls the HMD 10, and outputs a display-purpose video image to the HMD 10. The second video processing apparatus 30 is a video processing apparatus, such as a personal computer workstation (PCWS), capable of communicating with the first video processing apparatus 20. The first video processing apparatus 20 and the second video processing apparatus 30 generate a composite video image of an MR space into which a real space and a virtual space are merged, and provide the composite video image to the HMD 10. In the present exemplary embodiment, a communication path between the first video processing apparatus 20 and the second video processing apparatus 30 is a communication path based on wired connection using Thunderbolt 3 or the like, but may be a communication path based on wireless connection.

The HMD 10 includes an image sensor 100 included in the image pickup unit, and a display element 110 included in a display unit.

The image sensor 100 includes a complementary metal-oxide semiconductor (CMOS) image sensor, a charge coupled device (CCD) image sensor, or the like. The image sensor 100 acquires a picked-up video image by imaging a real space via an optical system (not illustrated), depending on an exposure period, a sensor gain, an exposure start timing, and the like set based on control signals from the first video processing apparatus 20.

The display element 110 includes an organic light emitting diode (OLED) display, a liquid crystal display (LCD), or the like.

The display element 110 presents a composite video image to the person wearing the HMD 10 via the optical system (not illustrated).

In the display system 1, a three-dimensional video image with a video image for right eye and a video image for left eye is used, and the image sensor 100 and the display element 110 form a pair, as each of a pair for right eye and a pair for left eye (not illustrated). A background-purpose video image to be the base of a composite video image and a position-detection-purpose video image for generating CG are generated from the picked-up video image picked up by the image sensor 100. A method of clipping the other from the picked-up video image of the same image sensor is used in the present exemplary embodiment, but separate image sensors can be used because the background-purpose video image and the position-detection-purpose video image are different in terms of required angle of view, resolution, image processing, and the like. In the HMD 10, an inertial measurement unit (IMU, a so-called position/posture sensor capable of calculating the position and posture of an apparatus by detecting a 3-axis angular rate and acceleration) (not illustrated) is mounted to detect position/posture information about the HMD 10. Known technologies are used for image pickup and display of a three-dimensional video image, and therefore the detailed description thereof will be omitted.

The first video processing apparatus 20 includes a pre-processing unit 200, a position detection unit 210, a CG generation unit 220, a storage unit 230, a video image combining unit 240, a video image selection unit 250, a post-processing unit 260, an abnormality detection unit 270, and a recording/reproducing unit 280.

The second video processing apparatus 30 includes a position detection unit 310, a CG generation unit 320, a storage unit 330, a video image combining unit 340, and a recording/reproducing unit 380.

The pre-processing unit 200 develops the picked-up video image picked up by the image sensor 100 transmitted from the HMD 10, in a manner suitable for each of the background of the composite video image and the position detection, and outputs the background-purpose video image to the video image combining unit 240 and the position-detection-purpose video image to the position detection unit 210. The pre-processing unit 200 also outputs the background-purpose video image to the video image combining unit 340 and the position-detection-purpose video image to the position detection unit 310.

The position detection unit 210 outputs information necessary for CG generation, such as a position for generating CG and an angle of a line of sight, based on the position-detection-purpose video image and the position/posture information about the HMD 10. The position detection unit 310 outputs information necessary for CG generation, such as a position for generating CG and an angle of a line of sight, based on the position-detection-purpose video image, and the position/posture information of the HMD 10.

The CG generation unit 220 generates predetermined CG, based on the output of the position detection unit 210. The CG is rendered based on Computer-Aided Design (CAD) data stored in a flash read only memory (FROM) or a hard disc drive (HDD) in the storage unit 230. The CAD data is, for example, downloaded from an external apparatus, and stored in the storage unit 230. The CG generation unit 220 functions as a first CG generation unit in the present disclosure. The CG generation unit 320 generates predetermined CG, based on the output of the position detection unit 310. The CG is rendered based on CAD data stored in a FROM or an HDD in the storage unit 330. The CG generation unit 320 functions as a second CG generation unit in the present disclosure.

The video image combining unit 240 generates a composite video image obtained by superimposing the CG on the background-purpose video image. The video image combining unit 340 generates a composite video image obtained by superimposing the CG on the background-purpose video image. The video image combining units 240 and 340 each function as a combining unit in the present disclosure.

The video image selection unit 250 selects either one of the composite video image generated by the video image combining unit 240 and the composite video image generated by the video image combining unit 340 as a video image to be used for the display-purpose video image, based on the detection result obtained by the abnormality detection unit 270. The video image selection unit 250 includes a buffer 250a for absorbing a timing difference when the video image is switched between the composite video image generated by the video image combining unit 240 and the composite video image generated by the video image combining unit 340. The video image selection unit 250 functions as a video image selection unit in the present disclosure.

The post-processing unit 260 subjects the display-purpose video image to image processing such as distortion correction of the optical system (not illustrated), and outputs the resulting video image to the HMD 10.

The abnormality detection unit 270 detects an abnormality of the video image input from the second video processing apparatus 30.

In the present exemplary embodiment, the video image input from the second video processing apparatus 30 is the composite video image generated by the video image combining unit 340, and whether there is missing image data in this composite video image or not is detected. When it is detected that there is missing image data in the composite video image, the abnormality detection unit 270 outputs this detection result to the video image selection unit 250. The abnormality detection unit 270 functions as an abnormality detection unit in the present disclosure. While the video image input from the second video processing apparatus 30 is described as a monitoring target, the state of connection (regardless of wired or wireless connection) with the second video processing apparatus 30 may be used as a monitoring target, and an abnormality of this state may be detected.

The recording/reproducing unit 280 records and reproduces output video images of the first video processing apparatus 20, using the storage unit 230. The recording/reproducing unit 380 records and reproduces output video images of the second video processing apparatus 30, using the storage unit 330. The second video processing apparatus 30 may be unconnected during the reproduction by the recording/reproducing unit 280. The recording/reproducing units 280 and 380 each function as a recording/reproducing unit in the present disclosure.

As described above, in the display system 1, an MR experience can be provided by the first video processing apparatus 20 alone, even in a state where the second video processing apparatus 30 is not connected. For example, operation may be divided so that highly accurate position detection and high quality rendering are enabled when the second video processing apparatus 30 is connected, and simple quality is provided when the first video processing apparatus 20 operates alone.

While one first video processing apparatus 20 and one second video processing apparatus 30 are illustrated in FIG. 1 and FIG. 2, a configuration in which, for example, a plurality of first video processing apparatuses 20 is connected to the second video processing apparatus 30 may be adopted.

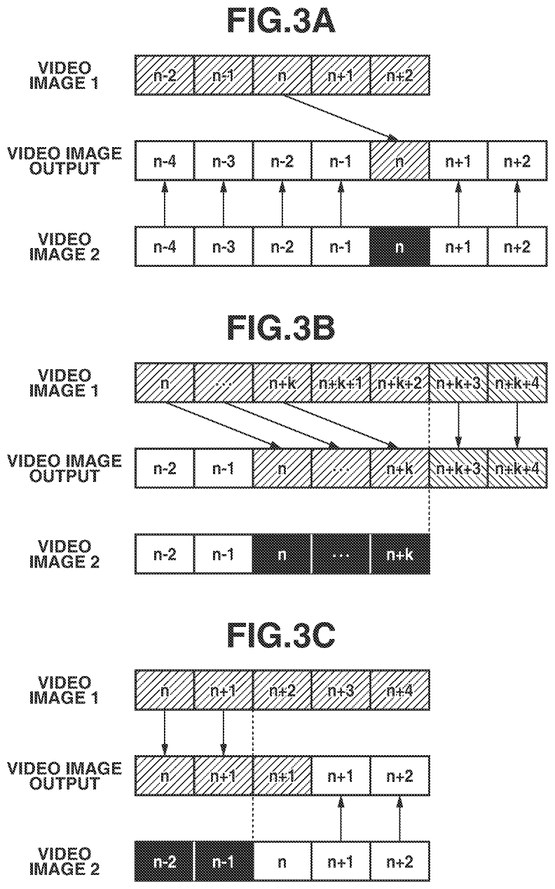

Processing executed by the video image selection unit 250 in the display system 1 will be described with reference to FIGS. 3A to 3C.

The term “video image 1” with diagonal lines represents an output of the video image combining unit 240 of the first video processing apparatus 20.

The term “video image 2” in white color represents an output of the video image combining unit 340 of the second video processing apparatus 30. The term “video image output” represents a display-purpose video image output to the HMD 10 by the video image selection unit 250. Numbers indicated as “ . . . , n−1, n, n+1, . . . ” are frame numbers. In this example, there is a relationship in which the video image 2 is longer than the video image 1 by two frames at the rear. A black frame represents a frame in which image data is missing.

In normal times (when no abnormality is detected by the abnormality detection unit 270), the video image 2 is used for the video image output.

FIG. 3A illustrates a situation where image data is missing at the frame number n of the video image 2.

Image data is not missing up to the frame number n−1, and therefore, the video image 2 is selected for the video image output. When it is detected that image data is missing at the frame number n by the abnormality detection unit 270, the video image selection unit 250 switches the video image output to the video image 1. At this moment, the buffer 250a absorbs the timing difference between the video image 1 and the video image 2. Afterward, the video image 1 is selected for the video image output, until there is no missing image data in the video image 2. Here, image data is missing in only one frame, and the video image 2 is selected again for the video image output at the frame number n+1 and subsequent frame number. Examples of the cause of such missing image data in a single frame can include an instantaneous interruption in communication between the first video processing apparatus 20 and the second video processing apparatus 30, and a reduction in frame rate due to a momentary rise in load on the second video processing apparatus 30 side.

In this way, whether image data is missing in the video image 2 input from the second video processing apparatus 30 is detected frame by frame, and the video image 2 is switched to the video image 1 frame by frame.

FIG. 3B illustrates a situation where image data is missing continues at the frame number n and subsequent frame numbers of the video image 2.

Image data is not missing up to the frame number n−1, and therefore, the video image 2 is selected for the video image output. When it is detected that image data is missing at the frame number n by the abnormality detection unit 270, the video image selection unit 250 switches the video image output to the video image 1. At this moment, the buffer 250a absorbs the timing difference between the video image 1 and the video image 2. Afterward, the video image 1 is selected for the video image output, until there is no missing image data in the video image 2.

In a case where, for example, image data is missing for k+1 frames consecutively in the video image 2, it is determined that an abnormality has occurred in the second video processing apparatus 30 or the connection of the second video processing apparatus 30, and the operation shifts to a single operating mode of the first video processing apparatus 20. At the time of shifting to the single operating mode, the timing difference between the video image 1 and the video image 2 is adjusted to skip from the frame number n+k to the frame number n+k+3, and the video image 1 is output afterward in a state where latency is low, in the illustrated example. Examples of the cause of such cases that image data is missing in a video image can include an interruption in communication between the first video processing apparatus 20 and the second video processing apparatus 30, and a hung up of the second video processing apparatus 30.

In this way, when the state where image data is missing in the video image 2 input from the second video processing apparatus 30 continues for a predetermined period, it is determined that the video image 2 is stopped, and the operation shifts to the single operating mode of the first video processing apparatus 20.

FIG. 3C illustrates a situation where the video image 2 is restored during the single operating mode of the first video processing apparatus 20.

If the video image output is switched to the video image 2 when the video image 2 is restored at the frame number n, the frame numbers go backward because of the timing difference between the video image 1 and the video image 2. Accordingly, the buffer 250a holds the frame number (the frame number n+1 in the illustrated example) of the video image output, and the video image output is switched to the video image 2 at the timing when the video image 2 at the same frame number as the held frame number is input. This make it possible to restore the operation to the operating mode in which the video image 2 is used for the video image output, without having the frame numbers going backward.

As described above, whether image data is missing in the video image (the composite video image generated by the video image combining unit 340) input from the second video processing apparatus 30 is detected, and either one of the composite video image generated by the video image combining unit 240 and the composite video image generated by the video image combining unit 340 is selected as a video image to be used for the display-purpose video image based on the result of this detection. This makes it possible to continue a high-quality MR experience without reducing the quality of the video image displayed in the HMD 10, even when, for example, a change occurs in the state of the communication between the first video processing apparatus 20 and the second video processing apparatus 30.

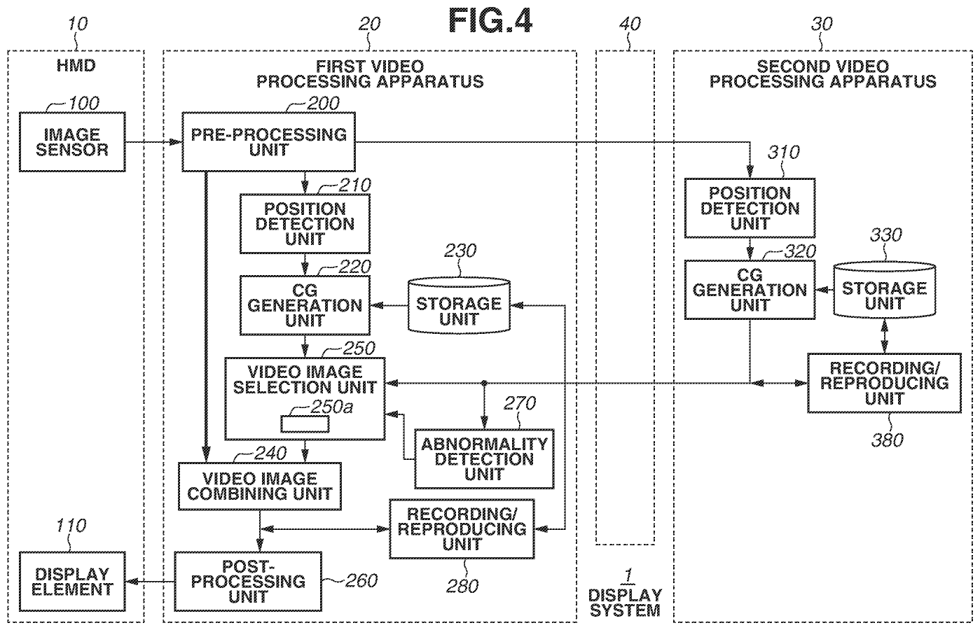

FIG. 4 is a block diagram illustrating a configuration of a display system 1 according to a second exemplary embodiment. Configurations similar to those in the display system 1 according to the first exemplary embodiment are assigned the same reference numerals as those in the first exemplary embodiment and will not be described, and a point different from the display system 1 according to the first exemplary embodiment will be mainly described.

As compared with the first exemplary embodiment, a configuration in which the video image combining unit 340 is not in a second video processing apparatus 30 is provided in the second exemplary embodiment.

In this case, a video image input from the second video processing apparatus 30 is CG generated by a CG generation unit 320, and an abnormality detection unit 270 detects whether image data is missing in the generated CG or not.

In a first video processing apparatus 20, a video image selection unit 250 is disposed in a stage before a video image combining unit 240. The video image selection unit 250 selects either one of CG generated by a CG generation unit 220 and the CG generated by the CG generation unit 320 as a video image to be used for a composite video image to be generated by the video image combining unit 240, based on the detection result obtained by the abnormality detection unit 270.

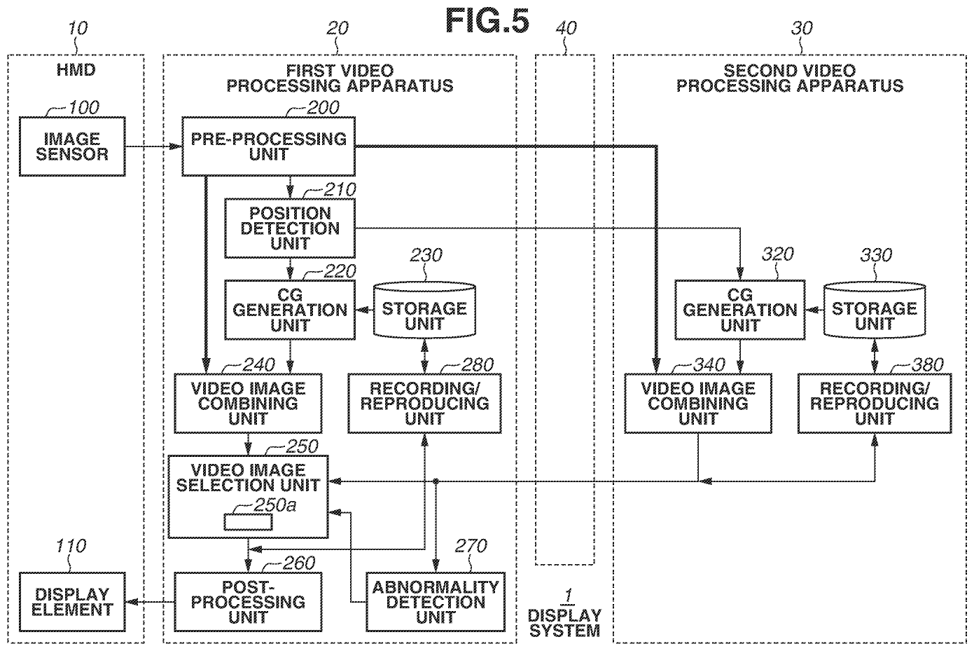

FIG. 5 is a block diagram illustrating a configuration of a display system 1 according to a third exemplary embodiment. Configurations similar to those in the display system 1 according to the first exemplary embodiment are assigned the same reference numerals as those in the first exemplary embodiment and will not be described, and a point different from the display system 1 according to the first exemplary embodiment will be mainly described.

As compared with the first exemplary embodiment, a configuration in which the position detection unit 310 is not in a second video processing apparatus 30 is provided in the third exemplary embodiment. A CG generation unit 320 of the second video processing apparatus 30 generates CG based on an output of a position detection unit 210 of a first video processing apparatus 20.

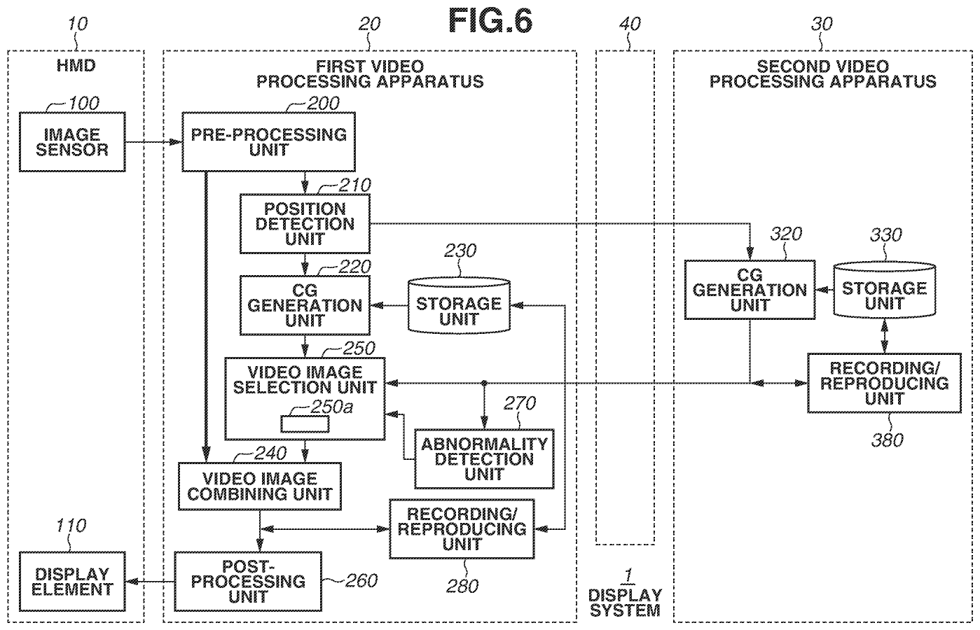

FIG. 6 is a block diagram illustrating a configuration of a display system 1 according to a fourth exemplary embodiment. Configurations similar to those in the display system 1 according to the first exemplary embodiment are assigned the same reference numerals as those in the first exemplary embodiment and will not be described, and a point different from the display system 1 according to the first exemplary embodiment will be mainly described.

As compared with the first exemplary embodiment, a configuration in which the position detection unit 310 and the video image combining unit 340 are not in a second video processing apparatus 30 is provided in the fourth exemplary embodiment.

As with the second exemplary embodiment, a video image selection unit 250 is disposed in a stage before a video image combining unit 240 in a first video processing apparatus 20. The video image selection unit 250 selects either one of CG generated by a CG generation unit 220 and CG generated by a CG generation unit 320 as a video image to be used for a composite video image to be generated by the video image combining unit 240, based on the detection result obtained by an abnormality detection unit 270.

As with the third exemplary embodiment, the CG generation unit 320 of the second video processing apparatus 30 generates CG based on an output of a position detection unit 210 of the first video processing apparatus 20.

The configuration example of the display system 1 is described with reference to FIG. 1 to FIG. 6, but is not limited to these examples. For example, a configuration in which the first video processing apparatus 20 is integral with the HMD 10, i.e., the first video processing apparatus 20 is disposed in a housing of the HMD 10 may be adopted.

The display system 1 is described to function as the MR system, but may function as a virtual reality (VR) system that uses a virtual space video image. Various parameters may also be appropriately designed, depending on the intended use of the display system 1, or the like.

The abnormality detection unit 270 may detect that video image is partially missing, instead of performing detection frame by frame, for the video image input from the second video processing apparatus 30. In this case, the video image selection unit 250 uses the composite video image generated by the video image combining unit 240, for a video image of a partially missing area.

The functional configuration illustrated in each of FIG. 2 and FIG. 4 to FIG. 6 may be implemented as hardware, and may be implemented by execution of software by an information processing apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-200846, filed Dec. 16, 2022, which is hereby incorporated by reference herein in its entirety.

What is claimed is:

1. A display system comprising:
a display apparatus of head-mounted type;
a first video processing apparatus including a first computer graphics (CG) generation unit that generates CG, and configured to output a display-purpose video image to the display apparatus; and
a second video processing apparatus including a second CG generation unit that generates CG, and configured to communicate with the first video processing apparatus,
wherein the first video processing apparatus includes
an abnormality detection unit that detects an abnormality of a video image input from the second video processing apparatus, or an abnormality of a state of connection with the second video processing apparatus, and
a video image selection unit that selects either one of a first video image using the CG generated by the first CG generation unit and a second video image using the CG generated by the second CG generation unit as a video image to be used for the display-purpose video image, depending on a result of detection by the abnormality detection unit.

2. The display system according to claim 1,
wherein the first video processing apparatus includes a combining unit that combines a predetermined video image and CG,
wherein the first video image is a video image obtained by superimposing the CG generated by the first CG generation unit on the predetermined video image, and
wherein the second video image is a video image obtained by superimposing the CG generated by the second CG generation unit on the predetermined video image.

3. The display system according to claim 2,
wherein the second video processing apparatus includes a combining unit that combines the predetermined video image and CG, and
wherein the video image input from the second video processing apparatus is a video image obtained by superimposing the CG generated by the second CG generation region on the predetermined video image.

4. The display system according to claim 2,
wherein the display apparatus includes an image pickup unit, and
wherein the predetermined video image is a video image picked up by the image pickup unit.

5. The display system according to claim 1, wherein the abnormality detection unit detects missing in the video image input from the second video processing apparatus.

6. The display system according to claim 5, wherein the abnormality detection unit detects missing in the video image input from the second video processing apparatus, frame by frame.

7. The display system according to claim 5, wherein the abnormality detection unit determines that the video image is stopped, in a case where missing in the video image input from the second video processing apparatus continues for a predetermined period.

8. The display system according to claim 1, wherein the video image input from the second video processing apparatus is the CG generated by the second CG generation unit.

9. The display system according to claim 1,
wherein the video image selection unit selects the second video image as the display-purpose video image, in a case where no abnormality is detected by the abnormality detection unit, and
wherein the video image selection unit selects the first video image as the display-purpose video image, in a case where an abnormality is detected by the abnormality detection unit.

10. The display system according to claim 1, further comprising a buffer configured to absorb a timing difference when the video image selection unit switches between the first video image and the second video image.

11. The display system according to claim 1, wherein the first video processing apparatus and the second video processing apparatus each include a recording/reproducing unit that records a video image and reproduces a video image, using a storage unit.

12. A video processing apparatus configured to output a display-purpose video image to a display apparatus of head-mounted type, the video processing apparatus comprising:
a first computer graphics (CG) generation unit configured to generate CG;
an abnormality detection unit configured to detect an abnormality of a video image input from another video processing apparatus including a second CG generation unit that generates CG, or an abnormality of a state of connection with the other video processing apparatus; and
a video image selection unit configured to select either one of a first video image using the CG generated by the first CG generation unit and a second video image using the CG generated by the second CG generation unit as a video image to be used for the display-purpose video image, depending on a result of detection by the abnormality detection unit.

13. A control method for a video processing apparatus that includes a first computer graphics (CG) generation unit configured to generate CG, and outputs a display-purpose video image to a display apparatus of head-mounted type, the control method comprising:
detecting an abnormality of a video image input from another video processing apparatus including a second CG generation unit that generates CG, or an abnormality of a state of connection with the other video processing apparatus; and
selecting either one of a first video image using the CG generated by the first CG generation unit and a second video image using the CG generated by the second CG generation unit as a video image to be used for the display-purpose video image, depending on a result of detection.

14. A non-transitory computer-readable storage medium storing a program for causing a computer to execute a control method for a video processing apparatus that includes a first computer graphics (CG) generation unit configured to generate CG, and outputs a display-purpose video image to a display apparatus of head-mounted type, the control method comprising:
detecting an abnormality of a video image input from another video processing apparatus including a second CG generation unit that generates CG, or an abnormality of a state of connection with the other video processing apparatus; and
selecting either one of a first video image using the CG generated by the first CG generation unit and a second video image using the CG generated by the second CG generation unit as a video image to be used for the display-purpose video image, depending on a result of detection.
